(19) United States
(12) Patent Application Publication
(10) Pub. No.: US 2009/0256677 A1
(43) Pub. Date: Oct. 15, 2009

(54) PASSIVE ENTRY SYSTEM AND METHOD

(75) Inventors: David A. HEIN, Sterling Heights, MI (US); Pawel W. SLEBODA, Bloomfield Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/100,489

(22) Filed: Apr. 10, 2008

(51) Int. Cl. G05B 19/00

(52) U.S. Cl. 340/5.72; 340/5.7

(57) ABSTRACT

A passive entry system is provided for permitting an authorized user access to a vehicle, building, or the like. The passive entry system includes a handle associated with a door and equipped with a plurality of sensors disposed in the handle's interior. The plurality of sensors can be coupled together to form a long-range proximity sensor capable of detecting a user in a target zone provided by the long-range proximity sensor. Upon subsequent validation of the user as an authorized user, the plurality of sensors may be decoupled to provide for individual detection of corresponding actions by the user's hand, including an intent to enter based upon a touching of the handle.

### TECHNICAL FIELD

The following relates to a passive entry system and method for detecting triggering events from multiple distances at or near a door handle, which provides ingress and egress to a vehicle, building, or the like.

A detailed description and accompanying drawings are set forth below.

### BRIEF DESCRIPTION OF THE DRAWINGS

FIG. 1 is a simplified, exemplary environmental diagram according to an embodiment of the present application;

FIG. 2 is a simplified, exemplary plan view of a door handle according to an embodiment of the present application;

FIG. 3 is a simplified, exemplary block diagram according to an embodiment of the present application;

FIG. 4 is a simplified, exemplary timing diagram according to an embodiment of the present application;

FIG. 5 is a simplified, exemplary cross-section of a door handle according to an embodiment of the present application; and

FIG. 6 is a simplified, exemplary diagram of sensor layout according to an embodiment of the present application.

### DETAILED DESCRIPTION

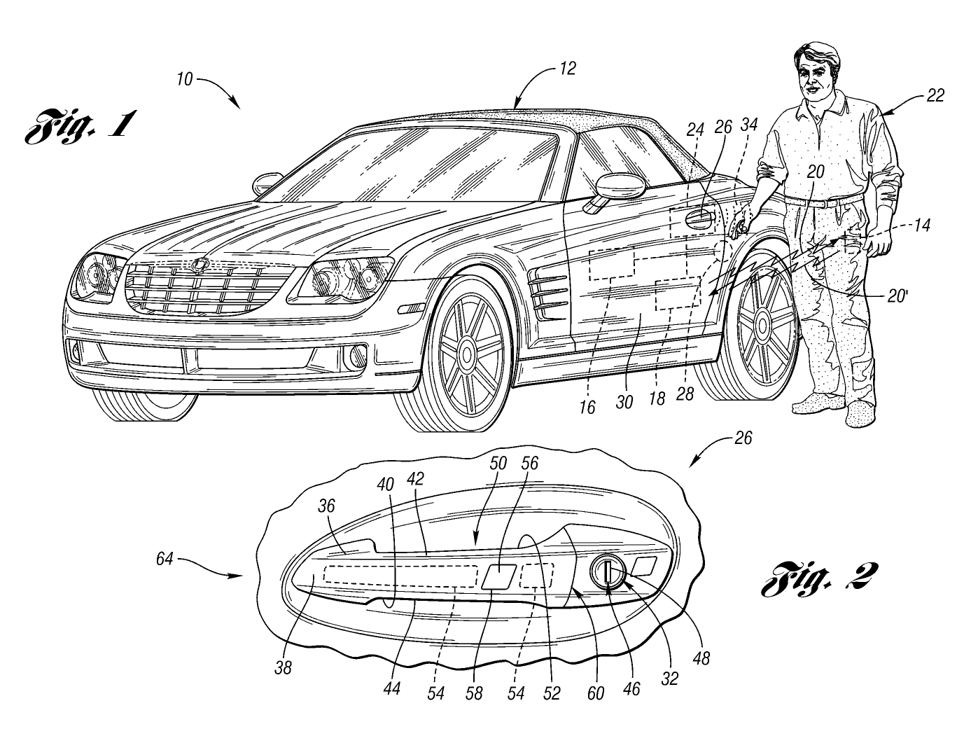

With reference to FIGS. 1-6, a more detailed description of embodiments of the system and method and various components thereof will now be provided. Controlling access to vehicles, buildings, or the like is increasingly safeguard one's vehicle, premises or personal property comes at the price of inconvenience.

Conventional systems utilize a mechanical key which is inserted into a cylindrical lock to allow the key holder to open the lock with a turn of the key in order to gain entry. Keyless entry systems are well known for providing an authorized user access to a vehicle, building, or the like, without the cumbersome and time-consuming manipulation of a lock with a mechanical key. Typical keyless entry systems include, for example, a keypad mounted at a door or remote keyless entry (RKE) systems for automobiles and homes.

The small controller that hangs off a car's sun visor (or integrated into an overhead console) to open and close a garage door is a common RKE device. Alternative RKE systems provide for remote control by a vehicle owner or user of vehicle security systems, door locks, trunk latch, exterior and/or interior lights, horn and/or alarms. In that regard, RKE systems for remote vehicle access and other remote operations include a remote control device or unit, which is commonly referred to as a “fob” or “key fob.” The remote control device has a transmitter, and wireless radio frequency (“RF”) signals are transmitted by transmitter of the remote control device that include commands for performing vehicle operations or functions such as unlocking the vehicle doors or starting the vehicle engine. Currently available RKE fobs are hand-held, portable devices, and may be separate units or may be part of an ignition key head.

Such RKE systems also typically include a receiver and/or device control unit installed in the vehicle. RF command signals transmitted by the remote control unit are received by the vehicle-mounted receiver and/or device control unit, and may be relayed to appropriate control circuitry, systems or subsystems in the vehicle in order to effectuate the desired operation or function. For example, the receiver and/or control unit may be provided in direct or indirect (e.g., over a vehicle bus) communication with door locking mechanisms to lock and unlock the vehicle doors in response to lock or unlock signals received from the remote unit. Similarly, the receiver and/or control unit may be provided in communication with other vehicle devices to control operation thereof in response to other signals received from the remote unit.

RKE systems may be active or passive in nature. Active entry systems require a vehicle owner or user to manually transmit a command signal, such as by actuating one or more push-buttons provided on the remote control unit. In passive entry systems, signals are automatically transmitted so that, for example, a vehicle door may be unlocked as the vehicle owner or user approaches the vehicle and/or touches the door handle to open the door, without the need for any action by the vehicle owner or user.

In that regard, in a passive keyless entry system, a remote unit, which may be referred to as a “fob” or a “card,” is typically provided with a transceiver for communicating with a transceiver and/or control unit installed in the vehicle. In such systems, the remote unit carried by an operator may be used, for example, to automatically unlock the vehicle as the operator approaches the vehicle, without the need for operation of any switch or pushbutton by the operator. Similarly, the system may further be designed to automatically lock the vehicle as the operator, carrying the remote unit, moves away from the vehicle. A vehicle-mounted transceiver and/or control unit is again provided in direct or indirect communication with control circuitry, systems or subsystems to effectuate a particular operation in response to signals received from the remote unit, such as door locking mechanisms to lock and unlock the vehicle doors.

To prevent unauthorized entry into a vehicle equipped with an RKE system, command signals from remote control units are typically encrypted, such as with a rolling-code encryption scheme where a security code is transmitted with the command signal, that code being different with every transmission. The vehicle-mounted device that receives the command signals is equipped with the same rolling-code encryption scheme in order to de-crypt a received command signal and determine which security code to expect with each command signal received. As a result, even if a command signal is intercepted by a third party, that signal cannot later be re-transmitted by the third party in order to gain entry into the vehicle, since the security code transmitted with that command signal will no longer be accepted as valid by the vehicle-mounted receiver and/or control unit.

RKE systems are referred to as “one-way” systems where communication or transmission of signals only takes place from the portable remote control device having a transmitter to the vehicle-mounted device having a receiver. However, as is again well known by those of ordinary skill, RKE systems may also be “two-way” in nature. In “two-way” RKE systems, the portable remote control device carried by the vehicle user or owner includes a transceiver, and the vehicle-mounted device also includes a transceiver. As both the remote control device and the vehicle-mounted device are capable of transmitting and receiving wireless signals, two-way communication between those devices is enabled.

Signals transmitted to or from the portable remote control device and/or the vehicle-mounted device in “two-way” RKE systems are again typically encrypted for security purposes. “Two-way” RKE systems also may be either active or passive in nature.

In “two-way” RKE systems, communication from the vehicle-mounted device or unit to the portable remote control device or unit may be for any of a number of purposes, such as for prompting a passive remote control device to transmit a signal, acknowledging the receipt of a command signal from a remote unit, or others. In that regard, the remote control device or unit may be provided with a display, such as a liquid crystal or light emitting diode display, so that the vehicle owner or user can confirm that a command signal has been received by the vehicle-mounted device or unit and that the command has been effectuated (e.g., the vehicle doors have been locked/unlocked; the vehicle engine has been started).

As mentioned above, passive entry systems differ from active entry systems in that no manipulation of buttons or switches of a remote control or key fob is necessary. Rather, a door can be unlocked as an authorized user approaches a vehicle or building. Passive entry function typically includes automatic data interrogation or identification of an operator held data medium, transponder or the like so as to ascertain whether an operator approaching a motor vehicle, for example, or about to open the vehicle's door is authorized for access. Corresponding control electronics within the vehicle conducts the interrogation or checks the identification of the operator. Additionally, passive entry systems often include one or more sensors located inside a door handle capable of detecting the presence of a person or a person's hand, in particular. In the motor vehicle example, with corresponding authorization of the operator, automatic unlocking of the vehicle takes place upon the detection of the operator's hand very near or touching the door handle.

Referring now to the drawings, FIG. 1 is a simplified, exemplary environmental diagram of an embodiment of a passive entry system 10 for a motor vehicle 12. It is fully contemplated that passive entry system 10 is equally applicable to control access to other objects, such as buildings. Passive entry system 10 comprises a portable remote device, hereinafter referred to as an electronic key 14. Electronic key 14 may be an operator held data medium or transponder, a separate key fob or smart card, part of a vehicle ignition keyhead, or any other suitable device known in the art. Passive entry system 10 further comprises a vehicle-mounted device or unit 16. Vehicle unit 16 may be an onboard computer for controlling several vehicle functions, such as locking or unlocking vehicle doors, activating or deactivating a vehicle security system, activating or deactivating vehicle interior and/or exterior lights, starting the vehicle engine, and/or others. Alternatively, vehicle unit 16 may be a separate module for performing the passive entry function.

To this end, vehicle unit 16 may include a wireless control module 18 and/or a door module 24. Alternatively, wireless control module 18 and door module 24 may be separate modules electrically coupled to vehicle unit 16. Wireless control module 18 may transmit a wireless signal 20, which may be a radio frequency (“RF”) signal, that includes a command message. Wireless control module 18 may transmit wireless signal 20 a distance or range (R) from vehicle 12 in order to communicate with electronic key 14. Wireless signal 20 may be received by electronic key 14, which may be located on the person of an authorized user 22.

Likewise, electronic key 14 may itself transmit a wireless signal 20′, which may also be a radio frequency (“RF”) signal, that includes a command message. Electronic key 14 may transmit wireless signal 20′ a distance or range (R) from vehicle 12 in order to remotely perform a desired vehicle operation or function represented by the command message of wireless signal 20′. Wireless signal 20′ may also be an identification or confirmation signal indicating that electronic key 14 corresponds to vehicle 12.

Wireless signal 20′ may be received at wireless control module 18 and communicated to vehicle-mounted device unit 16, which may be mounted at any suitable location on the vehicle 12. Vehicle-mounted device unit 16 can relay the command message of the wireless signal 20′ to an appropriate vehicle function or device in order to effectuate the command, such as activating or deactivating a vehicle security system, activating or deactivating vehicle interior and/or exterior lights, and/or others. In that regard, the vehicle function or device may be, for example, a computer, microprocessor, control circuit, logical device, vehicle system, vehicle device, or vehicle subsystem, or other. Relay of the command message by vehicle-mounted device unit 16 may include translation of the command message of wireless signal 20′ into an output control signal. Vehicle-mounted device unit 16 may be provided in direct communication with a vehicle function, or may be provided in communication with a vehicle function indirectly, such as over a vehicle data or communications bus (not shown).

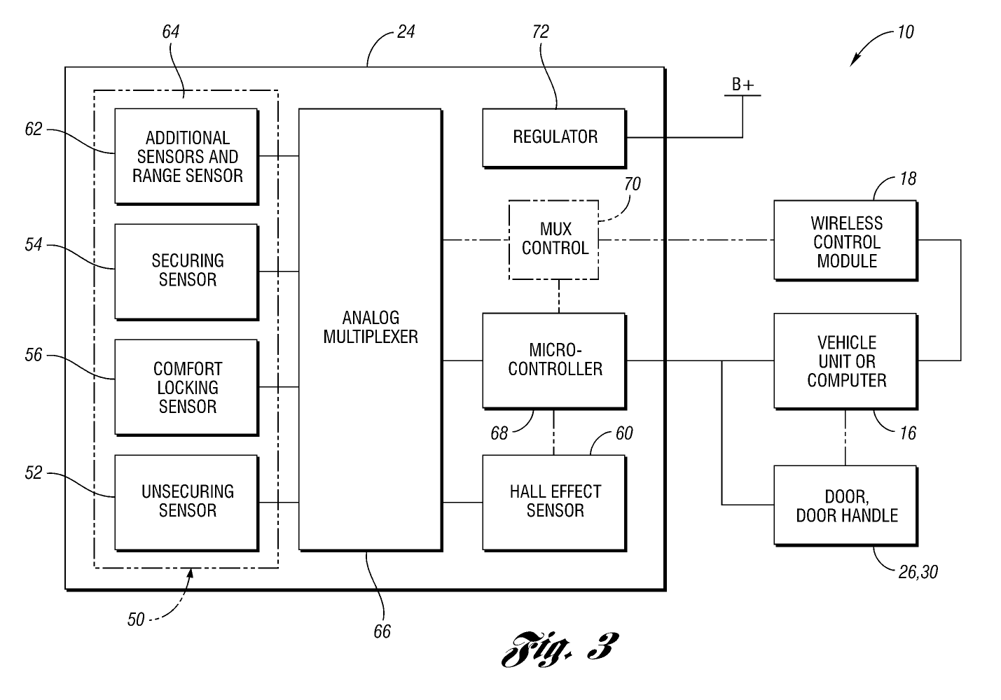

According to an embodiment of the present application, vehicle unit 16 and wireless control module 18 may be linked to a door module 24, as shown in FIG. 1, or may be part of door module 24. Door module 24 may include, or be coupled to, a handle 26 connected with a latch 28 for opening and closing a door 30. Door module 24 further includes a lock 32 (shown in FIG. 2) associated with handle 26 for securing latch 28. When locked, manipulation of handle 26 does not release latch 28 to provide entry to vehicle 12. However, if door module 24 receives an appropriate unlock signal and unlocks door 30, then an authorized user can pull handle 26 releasing the door latch and subsequently opening the door.

As depicted in FIG. 1, an operator or user 22 of vehicle 12 may move a hand into a target sensing zone 34. A proximity sensor (not shown) may be disposed within door handle 26 for sensing a hand in the target sensing zone 34. To this end, the proximity sensor may be a capacitive-type sensor having a sensing electrode in communication with control electronics for detecting a change in the dielectric constant caused by an object in the target zone. Detection of a hand in target zone 34 may alert the wireless control module 18, which then polls or interrogates the user 22 to determine if the user is authorized to gain access to the vehicle 12. In this regard, wireless control module 18 transmits wireless signal 20, which can be an interrogation signal, to electronic key 14. If electronic key 14 is present and valid, it returns wireless signal 20′, which can be a confirmation signal, identifying that it corresponds to vehicle 12. Assuming the electronic key 14 is valid and an authorized user is confirmed, door module 24 wakes up.

In the awaken state, door module 24 may be configured to detect an initial touching of the door handle 26. Consequently, door module 24 may send an unlock message unlocking the lock 32. Upon the user grabbing the door handle 26, the door latch 28 may be actuated in anticipation of the user pulling the handle 26 to open the door 30. With the door 30 unlocked, the door 30 may now be pulled open so that the user 22 can gain access to the vehicle 12.

Referring now to FIG. 2, a door handle 26 according to an embodiment of the present application is shown. In this embodiment, door handle 26 can be a handle to a vehicle. However, it is fully contemplated that door handle 26 can be a handle to another object, such as the door of a building, a safe, or the like. Door handle 26 may include an external surface 36, for example, a front surface 38, a rear surface 40, an upper surface 42 and a bottom surface 44. Front surface 38 faces generally outward away from vehicle 12, while rear surface 40 can be provided opposite the front surface 38 facing towards the vehicle 12 proximate the vehicle's door 30. Similarly, upper surface 42 may be disposed between front surface 38 and rear surface 40 and generally face the sky, while bottom surface 44 may be located generally opposite upper surface 42 facing the ground.

Door handle 26 may further include lock 32, which can be operable in a locked or unlocked state to secure or unsecure the vehicle 12, respectively. Lock 32 corresponds to vehicle latch 28 that may be manipulated by the pulling of door handle 26 to open the door 30. Pulling the vehicle door handle 26 in the locked state prevents the latch 28 from actuating thereby precluding access to the vehicle 12. Accordingly, lock 32 and latch 28 may be in communication with the door module 24 or a part thereof. Therefore, door module 24 can control lock 32 in the appropriate state. Lock 32 may be a cylindrical lock, or alternatively, another type of suitable lock known to one of ordinary skill in the art. Lock 32 may also be provided with a plug 46 having a keyhole 48. Accordingly, lock 32 may be manipulated manually with the turn of a corresponding key to lock or unlock the vehicle 12. This allows a user to still gain access to vehicle 12 with a valid mechanical key in the event the user does not have electronic key 14, or chooses not to utilize it.

Door handle 26 may house a plurality of sensors 50 for performing the passive entry function within its interior. For example, door handle 26 may include an unsecuring sensor 52 in communication with door module 24 and proximate the rear surface 40. Touching the rear surface 40 of door handle 26 can be detected by unsecuring sensor 52 and result in the unlocking of vehicle 12, assuming the user 22 has been authorized. To this end, unsecuring sensor 52 may be a capacitive touch sensor, inductive sensor, infrared sensor, mechanical sensor, or the like. In addition to unsecuring sensor 52, the plurality of sensors 50 may include a securing sensor 54. Accordingly, FIG. 2 illustrates a two-part securing sensor having two sensing electrodes proximate the front surface 38 of door handle 26. A lasting touching (e.g., greater than 0.5 seconds) of the securing sensor 54 can cause door module 24 to lock the vehicle 12 securing it from unwanted entry. Thus, securing of the vehicle 12 can be accomplished by a lasting touching over a large area of the front surface 38.

In an embodiment of the present application, door module 24 may require a lasting touching detected at both sensing electrodes. Alternatively, a lasting touching detected by only one of the sensing electrodes of securing sensor 54 may be sufficient. It should be noted, however, that securing sensor 54 may include only one sensing electrode or several sensing electrodes without departing from the scope of the present application.

Additionally, the plurality of sensors 50 of door handle 26 may include a sensor for performing a specific function not necessarily related to controlling access to the vehicle 12 through the door 30. For example, at least one of the plurality of sensors 50 may include a comfort locking sensor 56. Triggering the comfort locking sensor 56 may cause the vehicle's windows and/or sunroof to close in the event they are open. According to one embodiment of the present application, comfort locking may only be activated by the exclusive touching of comfort locking sensor 56. The simultaneous touching of other sensors or regions of door handle 26 may immediately interrupt the comfort locking function in concern for safety. To this end, door handle 26 may include special markings 58 or a slight recessed area identifying specifically where the sensing electrode of comfort locking sensor 56 is disposed. Other functional sensors provided as part of door module 24 may include sensors for activating interior or exterior lights, the vehicle's engine, heated seats, or the like.

Door handle 26 may also include a hall effect sensor 60 disposed between the movable portion of the door handle and the stationary portion of the door handle. The Hall effect refers to the potential difference, known as Hall voltage, on the opposite sides of an electrical conductor through which an electric current is flowing, created by a magnetic field applied perpendicular to the current. When the door handle 26 is pulled, the movable portion is separated from the stationary portion causing a change in the Hall voltage. Door module 24 can sense this change and, therefore, detect the pull of the door handle 26. According to an embodiment of the present application, the hall effect sensor 60 may active a door assist function. That is, triggering the hall sensor may cause a dedicated motor to rotate easing the door open. Of course, triggering the hall sensor may activate additional vehicle functions in addition to, or in place of, the door assist function.

For convenience, it may be desirable for the passive entry system 10 to consistently unlock the door for an authorized user 22 prior to the user pulling the door handle 26. In order for this to occur, the control electronics must complete its sequence of functions in less time than it takes a user to approach and pull the handle 26. A user can become annoyed when the door handle 26 must be pulled a second time in order to gain entry. Thus, a race situation occurs between the user 22 and the door module 24 when the passive entry function is initiated. In order to avoid this race situation, the passive entry function may be initiated as soon as is practicable without sacrificing security. Therefore, the passive entry function may begin prior, even if only slightly, to the touching of the handle 26 by the user 22.

Accordingly, passive entry system 10 may include a proximity sensor having a target sensing zone 34 defined by an area surrounding the door handle 26. The proximity sensor can permit detection of a hand approaching, but not yet touching the door handle 26. In order to effectuate detection of a hand in the target zone 34, the plurality of sensors 50 of door handle 26 may further include a long-distance detection sensor 62 in communication with the door module 24 and having a sensing electrode designed to detect objects at a distance from the door handle 26. The long-distance detection sensor 62 may also be a capacitive-type sensor.

Because space inside door handle 26 may be limited, it may be difficult to provide a proximity sensor capable of detecting an approaching user in the desired target zone. That is, the additional long-distance detection sensor 62, alone, may not provide sufficient detection range. According to an object of the present application, the additional long-distance detection sensor 62 may be coupled to some or all of the plurality of sensors 50 to effectively create, if only temporarily, a single long-range proximity sensor 64 capable of detecting a user entering the target zone 34. To this end, the passive entry function can be reliably initiated prior to the touching of the door handle 26 allowing the control electronics of the door module 24 to complete its sequence before the user pulls the door handle 26 in an attempt to gain entry.

In this regard, FIG. 3 provides a simplified, exemplary block diagram schematically depicting the passive entry system 10 according to an embodiment of the present application. As seen therein, door module 24 provides a plurality of sensors 50 that may include one or more functional sensors such as unsecuring sensor 52, securing sensor 54, and/or comfort locking sensor 56. Additional functional sensors may also be provided without departing from the scope of the present application. The plurality of sensors 50 may also include long-distance detection sensor 62 as described previously with respect to FIG. 2. The plurality of sensors 50 may be in electrical communication with an analog multiplexer 66 that allows some or all of the plurality of sensors 50 to be connected in parallel to provide accurate long distance detection of an object in the target zone 34. Analog multiplexer 66 may further decouple the plurality of sensors 50 permitting the sensors to detect and perform individually according to their corresponding function.

Door module 24 may further include a controller 68 in communication with the multiplexer 66. Controller 68 may signal the multiplexer 66 to couple the plurality of sensors 50 together to effectively provide the single long-range proximity sensor 64. Upon the detection of an object in the target zone 34 by the combination of sensors 50 connected in parallel, controller 68 may then instruct the multiplexer 66 to decouple the sensors 50 for individual operation corresponding to their respective function. To this end, controller 68 may further communicate with a central vehicle computer, which in turn communicates with multiple electronic modules for performing specific vehicle functions. Alternatively, controller 68 may communicate directly with electronic modules. One example of an electronic module in direct or indirect communication with controller 68 is wireless control module 18. Thus, upon detection of a user approaching door handle 26 in the target zone 34, controller 68 may instruct wireless control module 18 to poll for a valid electronic key 14, as previously described. Assuming a valid electronic key 14 is identified, controller 68 may determine that the user is authorized to gain access to the vehicle 12. Accordingly, the plurality of sensors 50 may become operable to perform their specified individual function.

It should be noted that control of the multiplexer 66 may be performed directly or indirectly by a separate multiplexer controller 70 instead of the controller 68 itself. For example, door module 24 may include multiplexer controller 70 in direct communication with the analog multiplexer 66 or indirectly through the controller 68 without departing from the scope of the present application. The various control configurations are limited only by design choices made by one of ordinary skill in the art.

Once the door module 24 is in the decoupled state, the individual sensors 50 may be activated. Unsecuring sensor 52, for example, may detect a touching of the door handle 26 and cause controller 68 to send an unlock signal to the door lock 32. When the door handle 26 is grabbed, actuation of the latch 28 occurs enabling the door 30 to open upon the pull of the door handle 26. Conversely, if a user desires to secure an unlocked vehicle from the outside, the user may perform a lasting touching of securing sensor 54, as previously described. Upon detection of this lasting touching of the securing sensor 54, controller 68 may instruct the door 30 to be locked. Moreover, a user may desire to close the windows and/or sunroof from outside the vehicle 12 if one or more is open or partially open. In that regard, the user may activate the comfort locking function by touching the comfort locking sensor 56. Thus, controller 68 may be in direct or indirect communication with a power window or sunroof module.

Hall effect sensor 60 may be in communication with the controller 68 indirectly through the multiplexer 66 as shown in FIG. 3, or may be directly connected to controller 68. As previously described, hall effect sensor 60 may detect the pulling of door handle 26 causing controller 68 to deliver an activation signal to a door assist module, which may operate a dedicated motor to help ease the door 30 ajar. Door module 24 may further include a voltage regulator 72 in order to power the electronic devices of door module 24.

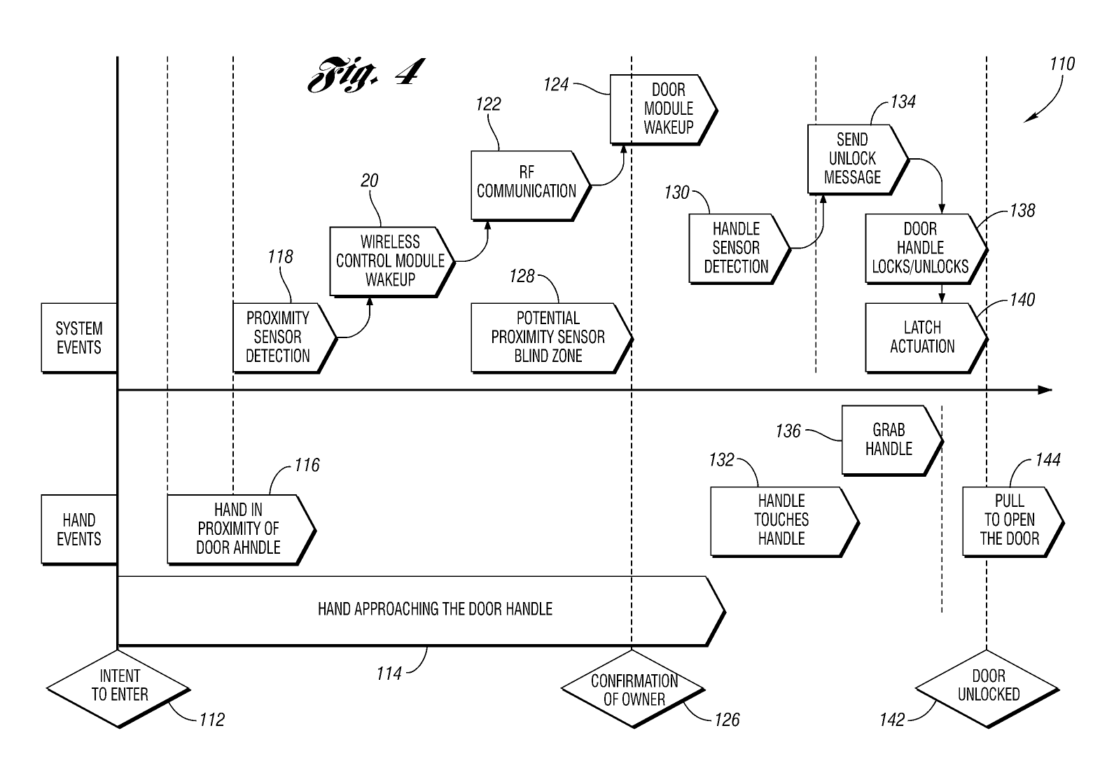

Referring now to FIG. 4, a simplified, exemplary flow diagram 110 depicting a timing sequence according to an embodiment of the present application is shown. For exemplary purposes, the timing diagram assumes the vehicle 12 is locked. Accordingly, multiplexer 66 may be configured such that the plurality of sensors 50 are in the coupled state to effectively create the long-range proximity sensor 64. A seen therein, the bottom section of the flow diagram demonstrates a series of hand events, while the upper section illustrates a series of corresponding system events of passive entry system 10. Certain milestones relating to the passive entry function are provided below the bottom section. Correspondingly, milestone 112 indicates a user's intent to enter the vehicle 12. Event 114 represents the duration of a hand approaching door handle 26. At event 116, the hand moves into proximity of door handle 26 defined by the target zone 34. Detection of the hand in the target zone is detected by passive entry system at event 118. Consequently, controller 68 wakes up the wireless control module 18 at event 120. Next, wireless control module 18 transmits a signal interrogating or polling for a valid electronic key 14 at event 122. If a valid electronic key 14 is identified during this communication, the door module 24 is awakened at system event 124. Correspondingly, passive entry system 10 confirms that the user is authorized to gain entry as denoted by milestone 126.

While the wireless control module 18 attempts to communicate with the electronic key 14 during validation of the user, there may be the potential for a proximity sensor blind zone period identified by event 128. Event 128 may occur because when user 22 is detected in the target zone 34, wireless RF signal 20 starts transmitting. Wireless signal 20 may be a low-frequency signal, which is very large compared to the low level signals detected by a capacitive-type proximity sensor. Accordingly, the low-frequency signal can disturb the capacitive readings making them unreliable while the wireless control module 18 is transmitting and receiving.

Once the door module 24 is awakened, multiplexer 66 may be instructed to decouple the plurality of sensors 50 that form the long-range proximity sensor 64 so that the one or more functional sensors can be operable to detect individual events corresponding to their respective functions. For example, unsecuring sensor 52 may now be configured to solely detect the touching of door handle at system event 130. Hand event 132 corresponds to a user 22 touching the door handle 26. As a result, door module 24 sends an unlock message to the door lock 32 at system event 134. Meanwhile, the user 22 may grab the door handle 26 illustrated at hand event 136. As the door handle 26 is being grabbed, the door module 24 unlocks the door 30 at event 138 and actuates the latch 28 at system event 140. Accordingly, milestone 142 denotes that door 30 is now unlocked. Therefore, the user 22 may successfully open the door 30 and gain access to the vehicle 12 by pulling the door handle 26 at hand event 144.

Of course, timing diagram 110 is merely exemplary and it is contemplated that the events may not all necessarily occur in the exact order shown. Further, the timing events may be modified, rearranged, or supplemented consistent with the scope of the present application.

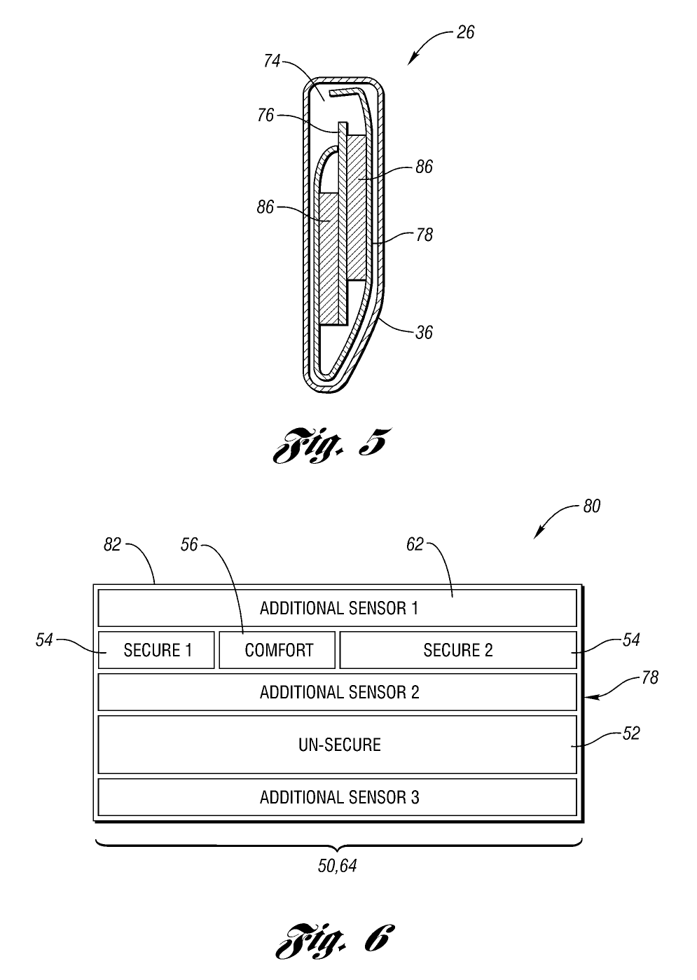

With reference now to FIG. 5, a simplified, exemplary cross-sectional view of a door handle 26 of a vehicle 12 according to an embodiment of the present application is shown. As seen therein, door handle 26 may include front surface 38, rear surface 40, upper surface 42, and bottom surface 44. At least a portion of door handle 26 may include a hollowed-out interior 74 for housing certain electrical components and/or sensors of the door module 24. To this end, a first printed circuit board (PCB) 76 may be disposed in the interior 74 of door handle 26. First PCB 76 may host select electrical components of the door module 24. Moreover, first PCB 76 may be a single-sided board or double-sided board for placing the electrical components. Still further, first PCB 76 may be a single-layer board or a multi-layer board. The PCB design may only be limited by available space or other design requirements and standards known to ordinary skill in the art, such as electromagnetic compatibility concerns.

Encircling the first PCB 76 may be a second PCB 78 as shown. Second PCB 78 may be a flexible PCB or similar type PCB that can be wrapped around the first PCB 76 such that it may be disposed near the interior surfaces of the door handle 26. Second PCB 78 may include the plurality of sensors 50. In this regard, the second PCB 78 may include several sensing electrodes corresponding to the one or more sensors. A simplified, exemplary layout 80 of the second PCB 78 according to an embodiment of the present application is shown in FIG. 6. As seen therein, second PCB 78 forms a relatively large sensing pad 82 for each of the door handle sensors of passive entry system 10. The sensors can be in electrical communication with first PCB 76 for relaying electrical signals during the passive entry function. As previously described, second PCB 78 may be a flexible PCB so that it can be folded inside the door handle 26 and cover most of the interior surface of the door handle 26.

Although the layout of the individual sensors provided on the second PCB 78 may vary, the layout shown in FIG. 6 is consistent with the exemplary door handle 26 described with respect to FIG. 2. To this end, the area taken up by the securing sensors 54 and comfort locking sensor 56 may be disposed generally adjacent the front surface 38 of the door handle 26 when folded or placed inside the door handle 26. The area of the sensing pad 82 occupied by unsecuring sensor 52 may be generally disposed adjacent the rear surface 40 of door handle 26. As shown in FIG. 6, second PCB 78 may provide space for additional sensors, which can include long-distance detection sensor 62 or additional functional sensors as previously described. The additional sensing electrodes may be juxtaposed such that they correspond to upper surface 42 or bottom surface 44 of the door handle 26.

In order to extend the sensing field of the sensors 50, second PCB 78 should have as little ground paths as possible. The long-range proximity sensor 64 can be a combination of the sensors 50 of second PCB 78 coupled together in parallel by multiplexer 66. As such, the combination of these sensors provides relatively accurate long-distance detection of a hand or body approaching the vehicle 12 and entering the target zone 34.

Referring back to FIG. 5, spacers 86 may be interposed between the first and second PCBs 76, 78 insulating the conductive material of the second PCB 78 from the conductive elements of the first PCB 76. Accordingly, spacers 86 may be non-conductive material such as a compressible foam material, silicon material, or the like. In addition to providing insulation between the components of the first and second PCBs, spacers 86 can also help keep the second PCB 78 as close to the interior surface of door handle 26 as is practicable to provided greater sensing capability and range.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A passive entry system for permitting access to an authorized user, the passive entry system comprising:
a handle associated with a door and having a latch for opening the door, the handle including an external surface defining an interior;
a lock associated with the handle for securing the latch; and
a plurality of sensors disposed in the interior of the handle and operable in a coupled state and a decoupled state, the plurality of sensors providing a long-range proximity sensor when combined in the coupled state and having a target zone for detecting the user approaching the door, at least one of the plurality of sensors including an unsecuring sensor for unlocking the door when in the decoupled state upon the detection of the authorized user's hand touching the handle.

2. The system of claim 1, further comprising a wireless communication module for validating the user's authorization upon the detection of the user in the target zone.

3. The system of claim 2, wherein the wireless communication module includes a transmitter for transmitting a wireless signal polling for a valid electronic key in the vicinity of the door.

4. The system of claim 3, wherein the wireless communication module includes a receiver for receiving authorization from the valid electronic key and, upon authorization, the plurality of sensors are decoupled.

5. The system of claim 1, further comprising a multiplexer for coupling and decoupling the plurality of sensors.

6. The system of claim 1, further comprising a controller in communication with the plurality of sensors, the controller configured to communicate with one or more electronic modules associated with the system.

7. The system of claim 6, wherein the one or more electronic modules includes a door lock module operable to unlock the door.

8. The system of claim 1, wherein at least one of the plurality of sensors includes a securing sensor for locking the door when in the decoupled state upon the detection of a lasting touching of the handle in a region corresponding to the securing sensor.

9. The system of claim 1, wherein at least one of the plurality of sensors includes a comfort locking sensor for closing one or more windows when in the decoupled state upon the detection of an exclusive touching of the handle in a region corresponding to the comfort locking sensor.

10. The system of claim 1, wherein at least one of the plurality of sensors includes a capacitive sensor dedicated to providing long-distance detection of the user in the target zone when coupled with the plurality of sensors to form the long-range proximity sensor.

11. A method for permitting access through a door by an authorized user according to a passive entry system, the method comprising:
detecting the user breaching a target zone of the door having a handle, the handle including a plurality of sensors coupled together to provide a long-range proximity sensor;
validating the user to determine if the user is authorized; and
upon validation of the user, decoupling the plurality of sensors to allow one or more of the plurality of sensors to detect a hand event associated with the user and corresponding to a system function.

12. The method of claim 11, wherein the plurality of sensors includes an unsecuring sensor, the system further comprising:
detecting a touching of the handle by the user at the unsecuring sensor; and
unlocking the door to provide the user access.

13. The method of claim 11, wherein the validating step comprises:
transmitting a wireless signal to poll for a valid electronic key in the vicinity of, and corresponding to, the door;
receiving a confirmation signal from the electronic key that the electronic key is valid.

14. The method of claim 13, wherein the wireless signal is transmitted by a wireless communication module having a transmitter and the confirmation signal is received by the wireless communication module receiver.

15. The method of claim 11, wherein the plurality of sensors are coupled and decoupled by an analog multiplexer.

16. The method of claim 11, wherein the door corresponds to a vehicle.

17. The method of claim 11, wherein the door corresponds to a building.

18. The system of claim 1, wherein the door corresponds to a vehicle.

19. The system of claim 1, wherein the door corresponds to a building.

20. A vehicle equipped with a passive entry system for permitting access to the vehicle by an authorized user, the vehicle comprising:
a door pivotably attached to the vehicle for providing access to the vehicle's interior;
a movable handle for opening the door and having a corresponding movable latch, the handle including an external surface and an interior;
a lock associated with the handle for securing the latch;
a plurality of sensors disposed in the interior of the handle and operable in a coupled state and a decoupled state, the plurality of sensors forming a long-range proximity sensor when combined in the coupled state providing a target zone for detecting the user approaching the door; and
a wireless communication module for communicating with an electronic key in the vicinity of the vehicle in order to validate the user's authorization upon the detection of the user in the target zone;
wherein at least one of the plurality of sensors includes an unsecuring sensor for unlocking the door when in the decoupled state upon the detection of the authorized user's hand touching the handle.
